(19) United States
(12) Patent Application Publication
(10) Pub. No.: US 2023/0292648 A1
(43) Pub. Date: Sep. 21, 2023

(54) AUTOMATED PLANT GROWTH FLOW USING GEL GROWTH MEDIUM

(71) Applicant: Christopher Papouras, Commerce, CA (US)

(72) Inventor: Christopher Papouras, Commerce, CA (US)

(21) Appl. No.: 18/121,745

(22) Filed: Mar. 15, 2023

Related U.S. Application Data
(60) Provisional application No. 63/269,379, filed on Mar. 15, 2022.

(51) Int. Cl. A01C 1/04; A01G 24/35; A01G 7/04

(52) U.S. Cl. CPC A01C 1/044; A01G 24/35; A01G 7/045; A01C 2001/048

(57) ABSTRACT

An automated system for plant growth may include a reactor to make a hydrogel solution. A hopper with a processor controlled valve or valves may deliver components to make the hydrogel solution in the reactor. The hydrogel solution may be poured into a tray to create a hydrogel mat or a hydrogel plug. A conveyor may move the hydrogel mat or the hydrogel plug to a nursery on a path in which the hydrogel mat or the hydrogel plug is seeded and is dibbled or scratched. The nursery may include a first position for a seed to germinate in the hydrogel mat or the hydrogel plug, and a second position for a plant to grow to a harvest state in the hydrogel mat or the hydrogel plug. The nursery may include a plurality of LED lights suitable for growth of a plant from the germinated seed.

### CROSS REFERENCE TO RELATED APPLICATION

This application claims the benefit of the filing date of U.S. Provisional Patent Application No. 63/269,379, filed on Mar. 15, 2022, the disclosure of which is incorporated by reference herein.

### FIELD OF THE INVENTION

The present invention relates generally to automated processes for use in growing crops, and more particularly to automated processes for formation and use of a horticultural hydrogel-based growing medium for germination and/or growing of plants and/or fungi.

### BACKGROUND OF THE INVENTION

Plants and crops are commonly grown in soil or similar growth medium, as well as in aqueous or aeroponic environments. Soil environments may vary in their suitability for plant and crop growth, and use of automated processes may be more limited when soil is the growth medium. The soil may be subject to growth of undesired bacteria or other matter. Moreover, the soil may foul automated machinery during operations, particularly if the soil is friable.

Other disadvantages may similarly stymie the growth of plants in aqueous and aeroponic environments. There, plants still have the laborious step of being moved from germination stations to those where the plant can be grown until harvest. While some gel-based systems may overcome some of these disadvantages, none provides a suitable environment from growth to germination.

### SUMMARY OF THE INVENTION

Some aspects provide automated farming operations relating to use of a horticultural hydrogel-based growth mediums.

In some embodiments the horticultural hydrogel-based growth medium is prepared in an automated process, using a predetermined formulation. In some embodiments the predetermined formulation is selected based on the particular plant to be grown in the growth medium. In some embodiments the predetermined formulation is one of a plurality of predetermined formulations, with each of the plurality of predetermined formulations varying from each other. In various embodiments the predetermined formulations may include one or more polysaccharide-based gelling agents, at least one liquid, and, in some embodiments, various elements, carbon, plant growth agents, and/or one or more agents with anti-bacterial effects, at least with respect to some bacteria. In some embodiments the predetermined formulations vary such that pH of resulting growth mediums differ depending on the selected predetermined formulation.

In some embodiments the ingredients of the selected formulation are provided to a reactor, in which the formulation is mixed to form a solution and, in most cases, heated. The solution may be poured into a tray, which may be a tray with a plurality of cavities, for example to allow formation of horticultural hydrogel-based plugs, or other structure, and allowed to at least partially solidify, generally by cooling, to form the horticultural hydrogel-based growth medium. The at least partially solidified gel-based growth medium may be dibbled in its upper surface, for example once per plug or in an equidistant or semi-equidistant pattern. In some embodiments the upper surface may also be scratched or abraded, and in some embodiments the horticultural hydrogel-based growth medium may be exposed to sanitizing UV light or some other sanitizing medium. A plant seed is inserted into the cavity formed by the dibble in the horticultural hydrogel-based growth medium.

In some embodiments the ingredients of the selected formulation are stirred and heated before cooling and poured into a receptacle for hydrogel formation. In some preferred embodiments, the ingredients are heated to 85° C., or heated to between 75° C. and 95° C. In other embodiments the ingredients are added to charged water. In some embodiments, the water is distilled, RO, or purified. In most embodiments the ingredients are added to the water and stirred at a speed of preferably 500 rpm, or between 300 and 700 rpm. The ingredients of the selected formulation and water after stirring and heating is cooled. In some preferred embodiments, the mixture is cooled to less than 70° C., or between less than 80° C. and 60° C.

In some embodiments of the invention a hydrogel comprising water, carrageenan, carbon, and an acid to adjust p-I has a hardness of between 100-1000 g/cm², a cohesiveness of between 55-90%, and a springiness of 100%. More preferably, the hydrogels have a hardness of between 350-800 g/cm², a cohesiveness of 65-80%, and a springiness of 100%. In some embodiments the hydrogels have an electroconductivity measurement of between 3.0-5.0 mS/cm. In other preferred embodiments of the present invention the horticultural hydrogels have an electroconductivity measurement of between 3.5-4.9 mS/cm.

In some embodiments an acid is used to adjust the pH of the horticultural hydrogel, and in some embodiments the following non-limiting list of acids and bases may be used: citric acid, phosphoric acid, or potassium hydroxide.

In most embodiments of the invention the hydrogel comprises 98% water or more. Surprisingly, the hydrogels of the present invention retain water content for up to 30 days. In other embodiments, the hydrogels of the present invention retain water content for up to 21 days, 14 days, or 45 days Even more surprisingly, the hydrogels can lose water such that the hydrogel comprises 60% or less and be rehydrated to 98% without losing efficacy (e.g., increased biomass and decreased time to germination). Thus, the hydrogels of some embodiments of the present invention have an increased resiliency of water retention and rehydration relative to that known in the art.

In some preferred embodiments the ingredients are in a dissolvable bag that will degrade when placed in water and mix any dry and wet ingredients contained therein.

The plants cultivable and propagable according to the invention can be any plants which can grow on a horticultural hydrogel. In particularly preferred embodiments, the products, and methods according to the invention are suitable for the cultivation of herbs, vegetables, greens, grasses, succulents, berries, ornamental plants, herbaceous perennials and/or woody plants. Examples of vegetables, including all kinds of leafy greens, include green lettuce, red lettuce, romaine lettuce, iceberg lettuce, butter lettuce, chop suey greens, endive, golden purslane, mina, mizuna, komatsuna, pakchoi, spinach, swiss chard, ruby chard, red mustard, watercress, redskin dwarf sweet pepper, radicchio, baby peppers, bok choy, Chinese broccoli, Chinese celery, curry leaves, lemon grass, pea shoots, sesame leaves, choy sum, tatsoi, frilly mustard, baby spinach, bloomsdale spinach, dakon sprout, salad savoy, frisee, green oakleaf, baby leek, garlic chives, marjoram, purslane sorrel, tarragon, broccoleaf, collard greens, dandelion greens, honey gem lettuce, kohlrabi, mesclun, miner's lettuce, mustard greens, arrowhead spinach, puntarelle, epazote, red watercress, Russian kale, scarlet butter lettuce, tat soi, upland cress, living watercress, broccolini, kale, read oak leaf, red salanova, sprouting broccoli, Chinese broccoli, broccoli rabe, green broccoli, Chinese spinach, mibuna, minutina, hops, cannabis, sweet pepper, ramsons, sprouting onion seeds, ‘little gem’ lettuce, ‘marvel of four seasons’ lettuce, ‘green frills’ mustard, gai choy mustard, land seaweed, Greek cress, summer savory, oriental radish (daikon), Chinese lettuce (Celtuce), fenugreek, Chinese cabbage (yow choy), napa cabbage, rainbow Swiss chard, specialty hot peppers, and Easter white eggplant.

Examples of herbs include rocket (rucola), sorrel, coriander, basil (common), basil (Thai), basil (lemon), Cayenne pepper, garlic chives, wild thyme, thyme (lemon), oregano, rosemary, thyme, chives, sage, cilantro, leaf radish, marjoram, lemon balm, Mache, chervil, dill, marjoram, sorrel, tarragon, ice plant, rhubarb, parsley, collard, celery, fennel, mache, tango, chervil, Italian parsley, rapini, Chinese parsley, green purslane, arugala ‘Giove’, basil (purple ruffles), lemon balm, lemon basil, and purple basil Examples of halophytes include samphire (glasswort), sea aster (spinach), salsola soda, sea beet, rock samphire, sea kale, New Zealand spinach, saltbush, and alexanders (smyrnium olusatrum). Examples of medicinal plants include peppermint, lavender, anisi fructus, echinaceae purpureae, ephedra, holy basil, sage, stevia, valeriana officinalis, ginseng, Peruvian ginseng (Maca), daffodil, crambe, camellia, Russian dandelion, St. John's wort, blue cohosh, roman coriander, holy ghost, masterwort, female ginseng, stinging nettle, yerba mansa, bloodroot, and drumstick tree. In embodiments, the plants or plant species intended to be cultivated (and hence intended to grow or growing) in the plant cultivation system may be plants growing under the same or similar conditions, such as rucola and basil.

Preferred ornamental plants encompass, for example, Phalaenopsis (orchids), Anthurium and Spalhiphyllum. Preferred herbaceous perennials encompass, for example, Echnacea, Helleborus and Heuchera. Preferred woody plants encompass, for example, Lycusm, Paulmwma and Vaccinium.

Examples of berries that could be grown on the horticultural hydrogels of the present invention are, but not limited to: strawberry, blackberry, raspberry, and blueberry. Berries show a wide range of freeze hardiness that allows specific cultivars to be grown in a wide variety of climates. As an example, the following blackberry cultivars are commonly grown in the United States: Cultivar Most cold hardy Kiowa Wisconsin. Michigan, Illinois, Arkansas, Missouri Arapaho Illinois, Nebraska, Ohio, Kentucky, Arkansas Shawnee Illinois, Ohio, Kentucky, Tennessee, Virginia Navaho Virginia, Maryland, Delaware, North Carolina Chickasaw N-S Carolina, Delaware, Maryland, Arkansas Least cold hardy Apache Georgia, North Florida, Mississippi, Alabama, and all can be grown on the present invention hydrogels. While berries are generally cultivated by cuttings and propagated in shallow flats with loamy soil, the hydrogels of the present invention are a clear advantage in that they protect the delicate root systems and are easily transferrable.

Further examples of vegetables that may be cultivated and propagated on the hydrogels of the present invention are, but are not limited to apples, corn, sunflowers, cotton, soybeans, canola, wheat, rice, sorghum, barley, oats, potatoes, oranges, alfalfa, lettuce, strawberries, tomatoes, peppers, crucifers, pears, tobacco, almonds, sugar beets, beans and other valuable crops.

It is evident that the processes and methods according to the present invention are not limited to the plants listed above.

In some preferred embodiments, the horticultural hydrogels may be used to grow fungi. These embodiments include, but are not limited to the following: Lentula edodes (shiitake), Agaricus spp. (white button), Antrodia spp. (Niu Zang), Plerotus spp. (oyster), Auricularia spp. (wood ear), Volvariella volvacea (straw mushroom), Flammulina velutipes (enokitake), Grifola frondosa (maitake), Ganoderm lucidum. Tremella fuciformis (white jelly or fungus ear), Volvariella volvacea (straw), Ganoderma lucidem (reishi). Hericium erinaceus, and Hvpsizygus marmoreus (bunashimeji).

The hydrogel can be made from a polysaccharide polymer, such as one or more selected from alginate and derivatives thereof, carrageenan, chitins, chitosan and derivatives thereof, cellulose and derivatives thereof, starch and derivatives thereof, cyclodextrin, dextran and derivatives thereof, gums, lignins, pectins, saponins, deoxyribonucleic acids, and ribonucleic acids. The hydrogel can be made from a polymer that is a polypeptide or protein selected from albumin, bovine serum albumin, casein, collagen, fibrinogen, gelatin and derivatives thereof, gliadin, sodium glycine carbonate, bacterial cell membrane enzymes, and poly (amino acids). As for a poly (amino acid), it is preferably selected from polyproline, poly(L-arginine), poly(L-lysine), polysarcosine, poly(L-hydroxyproline), poly(glutamic acid), poly(S-carboxymethyl-L-cysteine), and poly(aspartic acid). Synthetic polymers can also be employed to make the hydrogel, such as when the polymer is a homo- or co-polymer comprised of a monomer selected from acrolein potassium, (meth)acrylamides, (meth)acrylic acid and salts thereof, (meth)acrylates, acrylonitrile, ethylene, ethylene glycol, ethyleneimine, ethyleneoxide, styrene sulfonate, vinyl acetate, vinyl alcohol, vinyl chloride, and vinylpyrrolidone.

Preferred hydrogel polymers are naturally occurring polysaccharides, including the natural polymers of alginic acid, carrageenan, chitosan, and carboxymethylcellulose (and its derivatives), positively and negatively charged polyelectrolytes (PEL), synthetic polymers, such as polyacrylonitrile (PAN) and poly(vinyl alcohol) (PVOH), film-forming polymer emulsions, e.g., homo/multi-polymers of vinyl acetate and various (meth)acrylate derivatives (e.g., methyl, ethyl, butyl), natural or synthetic rubber emulsions and dispersions, natural or chemically modified proteins, polyphenolic compounds, such as tannin-based complexing agents and derivatives thereof, and the like, and mixtures thereof. Also, grafted derivatives of these using a synthetic monomer, such as AAc, acrylonitrile, AAm, and the like, and mixtures thereof, afford hydrogel components in some embodiments of the invention.

Particularly preferred hydrogel polymers are selected from polyacrylonitrile, alginic acid (sodium salt, various molecular weights), chitosan (various degrees of deacetylation and molecular weights), carrageenan (kappa), sodium salt of carboxymethylcellulose, pectin, natural and seminatural gums, such as starch, xanthan, gellan, carrageenan, gum arabic, guar gum, ghatti gum, tragacanth gum, pontianac gum, karaya gum, agar-agar, methyl cellulose, and hydroxypropyl methylcellulose, natural and modified proteins, such as gelatin, collagen, albumin, bovine serum albumin, fibrinogen, casein, gliatin and the like, polyphenolic materials, such as tannin, tannic acid, galotannins, catechin, chlorogenic acid, arbutin, and the like, poly(diallydimethyl ammonium chloride), gelatin with tannic acid as complex-forming agent, polyethyleneimine (PEI), and PVOH before being crosslinked by any chemical or physical methods. In terms of the ethylenically-unsaturated monomer, it is preferably selected from acrylamide (AAm), N-isopropyl acrylamide (NIPAM), 2-hydroxyethyl (meth)acrylate (HEA, HEMA), acrylic acid (AAc), salts of acrylic acid (potassium, sodium and ammonium), potassium salt of 3-sulfopropyl acrylate (SPAK), poly(ethylene glycol)acrylate, poly(ethylene glycol)alkyl ether acrylate, methacrylic acid-2-dimethylaminoethyl ester, dimethylaminoethyl acrylate and diallyldimethylammonium chloride (DADMAC). A still more particularly preferred hydrogel component of the invention is selected from the group consisting of sodium carboxymethylcellulose, sodium starch glycolate, sodium carboxymethyl starch, dextran, dextran sulfate, chitosan, carrageenan, xanthan, gellan, hyaluronic acid, sodium alginate, pectinic acid, deoxyribonucleic acids, ribonucleic acid, gelatin, albumin, polyacrolein potassium. sodium glycine carbonate, poly(acrylic acid) and its salts, polyacrylonitrile, polyacrylamide, poly(styrene sulfonate), poly(aspartic acid), polylysine, polyvinylpyrrolidone, polyvinyl alcohol, CARBOPOL, ultramylopectin, poly(ethylene glycol), neutral cellulose derivatives, microcrystalline cellulose, powdered cellulose, cellulose fibers, carbon fibers (including nanotubes), dissolvable suture materials, and starch. Polyamides including vinyl caprolactam, polyethylene glycol, and polylactic acid, polyesters including polyglycolic acid, and dialdehydes may comprise or be additives to the horticultural hydrogel.

More preferably, the hydrogel comprises primarily carrageenan in the absence of a second polysaccharide or polymer.

In some most preferred embodiments, the hydrogel comprises carrageenan and carbon. The carrageenan and carbon have the surprising properties of being antimicrobial, thus eliminating the need for additive antimicrobial components.

The horticultural hydrogel of the present invention may be strengthened through post-crosslinking which may be accomplished chemically, physically or by any other method, including irradiation. Preferred post-crosslinking chemical agents include any multifunctional crosslinkers (e.g., containing hydroxyl, carboxyl, amine, epoxy, amide, urethane groups, and the like), divalent/multivalent metallic cations (e.g., calcium, magnesium, zinc, copper, barium, iron, aluminium, chromium, cerium), phosphates (e.g., pentasodium tripolyphosphate (TPP)), chromates (e.g., dipotassium dichromate), borates (e.g., sodium tetraborate decahydrate), peroxides (e.g., t-butyl hydroperoxide), glycidyl(meth)acrylate, ethylene glycol diglycidyl ether, glutaraldehyde, glycerin, glycols, polyamidoamine epichlorohydrin resin, TMPTA, and the like, and mixtures thereof. Representative crosslinking methods include thermogelation, ionotropic gelation, cryogelation, radiation-induced gelation, chemical gelation, coagulation, crystallization, vulcanization, curing, and combinations thereof. More preferred post-crosslinking methods employ ionotropic gelation (e.g., using anhydrous calcium chloride, cupric sulfate, ammonium cerium (IV) nitrate, ferric chloride hexahydrate, sodium tetraborate decahydrate, zinc chloride, aluminum chloride hexahydrate, chromium chloride, and anhydrous TPP) and cryogelation (e.g., by applying freeze-thaw cycles to PVOH solutions and using another cryogelable materials).

As mentioned above, the growth medium comprises further additives, such as, for example, nutrients. The growth medium can, for example, contain nutrients such as, for example, macronutrients and micronutrients; vitamins, phytohormones, further gelling agents, sugar and/or others. All the additives promote or support the growth of the various plant species. This can occur in different ways. For instance, the additives can directly support plant growth, for example by providing building blocks for the formation of cells and the like, or they can only indirectly support plant growth, for example by preventing or curbing the growth of competing organisms, such as bacteria. The additives are each selected and combined depending on the plant species to be cultivated.

In some embodiments, additives which prevent or curb the growth of competing organisms, such as bacteria, fungi and the like, are generally not needed in the horticultural hydrogel of the present invention. It was found that the addition of carbon to the carrageenan gel prohibits unintended bacterial or fungal growth. The addition of relevant additives is therefore not necessary according to some embodiments of the invention.

Suitable nutrients that may be added to the hydrogels of the present invention encompass macronutrients, such as nitrogen (N), phosphorus (P), potassium (K), calcium (Ca), magnesium (Mg) and sulfur (S), the macronutrients preferably being present in the growth medium in the form of chemical compounds which contain the respective macronutrient and make it available for the plants. The growth medium comprises, for example, macronutrients in the form of KNO3, NH4NO3, MgSO4×7 H2O, KH2PO4 and/or CaCl₂)×2 H2O The concentration is from 100 to 2000 ppm.

Furthermore, suitable nutrients that may be added in some embodiments of the invention encompass micronutrients, such as boron (B), iron (Fe), iodine (I), cobalt (Co), copper (Cu), manganese (Mn), molybdenum (Mo), sodium (Na) and zinc (Zn), the micronutrients preferably being present in the growth medium in the form of chemical compounds which contain the respective macronutrient and make it available for the plants. The growth medium comprises, for example, macronutrients in the form of MnSO4×H2O, ZnSO4×7 H2O, H3BO3, Na2MoO4×2 H2O, CuSO4° 5 H2O, KJ and CoCl2×6 H2O and NaFe EDTA The concentration in the growth medium is from 0.01 to 50 ppm.

Suitable vitamins and vitamin-like substances that may be components of the hydrogels of the present invention are, for example, thiamine, nicotinic acid, pyridoxine, glycine, and myo-inositol. The concentration in the growth medium is from 0.01 to 200 ppm.

Phytohormones control certain growth processes in plants, and so their admixture and concentration are selected depending on the plant species and the purpose of growth (root formation, shoot formation, branching, extension, etc.). Thus, phytohormones may comprise some embodiments of the hydrogels of the present invention. Those skilled in the art are capable of making an appropriate selection of phytohormones, and of the other additives defined herein, and of choosing suitable concentrations in each case. The hydrogel can, for example, comprise phytohormones from the following groups of active ingredients: abscisic acid, auxins. cytokinins, gibberellins. The phytohormone(s) is/are present in the growth medium as, for example, indole-3-acetic acid (IAA), 4-(indo-3-yl) butyric acid (IBA), 1-naphthylacetic acid (NAA), 6-benzylaminopurine (BAP), kinetin (KIN), zeatin (ZEA) or 2-isopentenyladenine (2iP) The concentrations in the growth medium are from 0.001 to 50 ppm.

In other embodiments of the present invention, fungi may be added to the hydrogel to confer benefit to a plant growing therein. These embodiments include, but are not limited to Dominikia, Rhizobium, Azorhizobium, Prunus maackii, Glomus iranicum, Mycorrhiza, Glomus intraradices, G. mosseae. G. aggregatum. G. etunicatum, Glomus deserticola, G. monosporum, G. clarum, Paraglomus brasiliamum, Gigaspora margarita, Rhizopogon villosulus, R. luteolus, R. amylopogon, I. fulvigleba, Pisolithus tinctorius, Suillus granulatus, Laccaria bicolor, L. laccata, Scleroderma cepa, S. itrinum, Trichoderma harzianum Rifai, and T. virens.

In some embodiments plant growth promoting bacteria (PGPB) may be added to the hydrogel to enhance growth of the plants therein. Some examples of PGPBs that may be added, without limitation are: Beauveria bassiana, Bacillus amyloliquefaciens, and Streptomyces lydicus.

What can likewise be used for stabilization is gelatin, preferably a gelatin foam. Especially preferred embodiments use gelatin portions which have a smaller size than a plant plug defined herein and to pour the growth medium according to the invention over said portions. Methods for producing suitable gelatin portions, for example gelatin cubes, are known to those skilled in the art. Furthermore, gelatin portions are commercially available. It is envisaged to preferably use gelatin portions which contain colloidal silver or colloidal copper, which thereby confer further sterilizing properties. Appropriate gelatin cubes are, for example, available as “Gelatamp” (Roeko, Coltene, gelatin sponge containing 5% colloidal silver, y-sterile) and “Gelita-Spon@” (Gelita medical, for example, cube, 10×10×10, 50, GS-310, Art. 00715118, without silver additive, foamed gel).

Organic material may also be added to the hydrogels of the present invention in some embodiments. Organic materials such as silica, wood, shell, sterilized hair or fur, wool, silk, bone, antler fragments, feather, or similar materials may be added to the hydrogels to impart cavities for root growth and nutrition.

In some embodiments one or more processors controls operations of hoppers and valves to provide the selected formulation to the reactor. Similarly, the one or more processors may control operation of the reactor, and device(s) for pouring of the solution into the tray or other structure or in receptacles to form a plug. The plant plugs according to some embodiments of the invention are suitable both for the manual cultivation of plants and for automated or semiautomated and machine cultivation of plants. Preferably, the plant plugs are for the automated or semiautomated cultivation of plants. In this connection and within the meaning of DIN V 19233, “automated” means that the cultivation is carried out by an apparatus which is equipped such that the apparatus works as intended (i.e., achieves a step forward in the cultivation of plants) without any participation at all by a person or with some participation by a person. In other words, the apparatus works autonomously. In the case of the automated or semiautomated cultivation of plants, a plant shoot or plant clone in particular is applied to a plant plug in an automated manner, the plant unit formed from plant part and plant plug is transferred into another device, another device part and/or a container; and/or the plant unit is transferred into a larger plant plug or a soil substrate, it being possible for the larger plant plug to be a plant plug according to the invention or a different type of plant plug.

The size of the plant plug, according to some embodiments of the invention, is matched with the plant to be grown, the germination time, the time from germination to harvest, or the size of the harvestable plant grown therein. In addition, it is also possible to produce relatively large plant plugs, for example those which contain recesses for smaller plant plugs and can be used in a “plug-in-plug” system. The plant plug can therefore have, for example, a size of 0.125 cm³ or greater, preferably 1 cm3 or greater. In other words, the plant plug preferably has a volume of from 0.125 cm3 to 27 cm3, more preferably from 10 cm3 to 18 cm3 In a most preferred embodiment, the hydrogel plug is 14 cm3. Since the plant plugs according to the invention are particularly suitable for automated high-throughput cultivation, the plant plugs can be particularly small in some embodiments. Therefore, in some embodiments, the plant plug has a volume of 27 cm3 or lower, preferably 16 cm3 or lower, or 10 cm3 or lower.

The hydrogels of the present invention can be made to form a plurality of commercially known trays. For instance, the hydrogels may be formed in any of the horticultural products listed at T.O. Plastics (toplastics.com/horticulture?hsLang=en). This includes, but is not limited to: plug trays, square plant pots, standard inserts, standard flats, true & slim flats, true & slim inserts, regional inserts & flats, propagation trays, sheet pots, round plant pots, or plant pie containers.

At the same time, the plant plug can have the shape of a cuboid, for example the shape of a cuboid having substantially equal sides. However, the plant plug according to the invention is not limited to this shape. For example, it is likewise conceivable to form plant plugs having a cylindrical, hexagonal, polygonal, or hemispheric shape.

Moreover, the horticultural hydrogels of the present invention may be poured into a sheet suitable for the growth of plants such as microgreens. In some embodiments the hydrogels of the present invention may reside in large pots, creating a “Dutch bucket system.” in these embodiments, approximately 18927 cm3 of liquid hydrogel is poured into a 5-gallon container to harden.

In some embodiments one or more conveyers, for example in the form of conveyor belts, may transport the trays, or plugs of the trays, sequentially to machines performing the dibbling, scratching, sanitizing, and seeding operations, all under control of the one or more processors as in some embodiments of the invention.

In some embodiments the conveyors transport the trays or plugs to a nursery, or a rack in or to be placed in a nursery, for germination of the seeds. In some embodiments the conveyors may directly provide the trays or plugs to a shelf in the rack. In some embodiments the conveyers may include a conveyor belt to transport the trays or plugs near or adjacent the rack, and a robotic arm may be used to place the trays or plugs on a shelf in the rack. In some embodiments the rack may be in the form of a leaf carrier. In some embodiments the rack may be in the form of an LED grow trolley, which may for example include LED lights which emit light suitable for seed germination and/or initial growth of a plant.

In some embodiments the solution may be poured into a tray containing a screen or mat, or the solution may be sprayed onto a screen or mat. Seeds may be placed on the screen or mat, prior to or as the solution gels. The screen or mat may thereafter be hung on a grow wall for germination and growth of plants or retained or placed in a horizontal orientation for germination and growth of plants.

Moreover, in some preferred embodiments of the invention, the hydrogel plugs may be placed in a receptacle adapted to be transferred directly to a station for full plant growth after germination. In these embodiments, the tray is adapted with a telescoping or expanding mechanism to expand with the growing plant.

In preferred embodiments, a dissolvable bag having wet and dry ingredients for a preferred horticultural hydrogel formulation is received by a user. The user places the container in a reactor that receives charged water. The mixture of the container and water is stirred and heated in the reactor and the resultant liquid hydrogel is poured into a preferred receptacle (e.g., plug, sheet, container), and cooled. The cooled horticultural hydrogel is indented with a dibbler to receive a seed and placed in a first growth position. The seeds placed within the indent germinate and grow to an early growth stage. At the early growth stage, the plants within the receptacle are moved to a second growth position. There the plants grow until harvest.

The methods of the present invention do not require plant plugs to be manually retrieved from an early growth stage to be placed in a second growth position.

These and other aspects of the invention are more fully comprehended upon review of this disclosure.

### BRIEF DESCRIPTION OF THE DRAWINGS

FIG. 1. is a flow diagram of the ingredients of a particular formulation placed in a reactor and the liquid hydrogel being placed with in a receptacle for cooling before a dibbler places an indentation, as in one embodiment of the present invention.

FIG. 2 is an illustration of a first growth position comprising a leaf carrier for receiving trays of the horticultural hydrogels having a seed for germination as in some embodiments of the invention.

FIG. 3 is an illustration of a grow trolley for receiving trays of the horticultural hydrogels having seeds for germination and early growth as in an embodiment of the invention.

FIG. 4 is a picture of a horticultural hydrogel plug with a germinated plant contained therein as in some preferred embodiments of the invention.

FIG. 5 is an illustration demonstrating the placement of the horticultural hydrogels on a grow wall as in some embodiments of the present invention.

FIG. 6 depicts the process of the present invention wherein the horticultural hydrogels are made, formed, and processed to become a mat or grow wall with a sheet of hydrogel, as in some embodiments of the invention.

FIG. 7 is an illustration of a dissolvable bag containing wet and dry ingredients of the horticultural hydrogel, as in some embodiments of the invention.

### DETAILED DESCRIPTION

Unless otherwise defined, all terms of art, notations and other scientific terms or terminology used herein are intended to have the meanings commonly understood by those of skill in the art to which this invention pertains. In some cases, terms with commonly understood meanings are defined herein for clarity and/or for ready reference, and the inclusion of such definitions herein should not necessarily be construed to represent a substantial difference over what is generally understood in the art. Many of the techniques and procedures described or referenced herein are well understood and commonly employed using conventional methodology by those skilled in the art.

The singular form “a”, “an”, and “the” include plural references unless the context clearly dictates otherwise. For example, the term “a cell” includes one or more cells, including mixtures thereof.

“Ambient temperature” as used herein is a temperature of between 18-24° C. and a relative humidity of between 60-95%.

As used herein, “biofertilizers” are microbial fertilizers that supply the plant with nutrients and thereby can promote plant growth in the absence of chemical fertilizers. Non-limiting examples of microbial isolates that can directly promote plant growth and/yield include N2-fixing bacteria Rhizobium and Bradyrhizobium species that, through symbiotic nitrogen fixation, can form nodules on roots of leguminous plants, in which they convert atmospheric N2 into ammonia which, in contrast to atmospheric N2, can be used by the plant as a nitrogen source. Other examples include Azospirillum species, which are free-living N2-fixers that can fertilize and increase yield of cereal crops such as wheat, sorghum, and maize. Despite Azospirillum's N2-fixing capacity, the yield increase caused by inoculation by Azospirillum is often attributed to increased root development and thus to increased rates of water and mineral uptake. In this respect, several rhizobacteria like Azotobacter spp. have been reported to be capable of producing a wide array of phytohormones (e.g., auxins, cytokinins) and enzymes (e.g., pectinase). Many of these phytohormones and enzymes have been shown to be intimately involved in the infection process of symbiotic bacteria-plant associations which have a regulatory influence on nodulation by Rhizobium. Biofertilizers can also affect the plant growth and development by modifying nutrient uptake. They may alter nutrient uptake rates, for example, by direct effects on roots, by effects on the environment which in turn modify root behavior, and by competing directly for nutrients (Gaskin et al., Agricult. Ecosyst. Environ. 12: 99-116, 1985). Some factors by which Biofertilizers may play a role in modifying the nutrient use efficiency in soils include, for example, root geometry, nutrient solubility, nutrient availability by producing plant congenial ion form, partitioning of the nutrients in plant and utilization efficiency. For example, a low level of soluble phosphate can limit the growth of plants. Some plant growth-promoting microbes are capable of solubilizing phosphate from either organic or inorganic bound phosphates, thereby facilitating plant growth. Several enzymes of microbial origin, such as nonspecific phosphatases, phytases, phosphonatases, and C-P lyases, release soluble phosphorus from organic compounds in soil. For example, an increased solubilization of inorganic phosphorus in soil has been found to enhance phosphorus uptake in canola seedling using Pseudomonas putida as well as increased sulfur-oxidation and sulfur uptake (Grayston and Germida, Can. J. Microbiol. 37: 521-529, 1991; Banerjee, Phytochemicals and Health, vol. 15, May 18, 1995).

“Biostimulants”, as used herein, can produce substances that stimulate the growth of plants in the absence of pathogens. For example, the production of plant hormones is a characteristic of many plant-associated microorganisms. Some microorganisms can also produce secondary metabolites that affect phytohormone production in plants. Probably, the best-known example is hormone auxin, which can promote root growth. Other examples include pseudomonads which have been reported to produce indole acetic acid (IAA) and to enhance the amounts of IAA in plants, thus having a profound impact on plant biomass production (Brown, Annual Rev. Phytopathology, 68: 181-197, 1974). For example, Tien et al. (Applied Environmental Microbiol., 37:1016-1024, 1979) reported that inoculation of nutrient solutions around roots of pearl millet with Azospirillum brasiliense resulted in increased shoot and root weight, an increased number of lateral roots, and all lateral roots were densely covered with root hairs. Plants supplied with combinations of IAA, gibberellins and kinetin showed an increase in the production of lateral roots similar to that caused by Azospirilla. Additionally, some rhizobacteria, such as strains of the bacterial species B. subtilis, B. amyloliquefaciens, and Enterobacter cloacae, promote plant growth by releasing volatile organic compounds, VOCs. The highest level of growth promotion has been observed with 2,3-butanediol and 3-hydroxy-2-butanone (also referred to as acetoin) as elicitors of induced systemic resistance. The cofactor PQQ has been described as a plant growth promoter, which acts as an antioxidant in plants. Other examples of biostimulants, as contemplated by the present invention, include products listed at https: growerssecret.com. Particularly, Grower's Secret Professional, Seaweed Powder 0-0-16, Soluble Corn Steep Powder 7-6-4, Granule's 8-3-1, Nitrogen 16-0-0, Liquid Nitrogen 8-0-0, Grower's Secret Microbes, Phosphorous 0-9-0, Seaweed Powder 0-0-16, or VitalVit Micronutrients. Other biostimulants include silica, amino acids, or agriculturally relevant enzymes.

“Carbon” as used in the present invention includes charcoal. Carbon may be commercially sourced such as through General Carbon, Fisher Scientific and VWR.

“Carrageenan” is an anionic polymer, a sulfated linear polysaccharide. Carrageenans have been classified into three different types, namely, κ-carrageenan, τ-carrageenan, and λ-carrageenan on the basis of the degree of sulfation. Carrageenan, as is contemplated in the present invention, refers to kappa carrageenan, which as the highest hydro-gel forming efficiency. The source may be purchased commercially such as Ricogel, Marcel, W-Hydrocolloids or CP Kelco. Carrageenan can also be purified from red algae as is known by those skilled in the art.

“Fertilizer” as used in the present invention provides nutrients such as phosphorus, nitrogen, carbon, hydrogen, oxygen, potassium, calcium, magnesium, sulfur, iron, boron, copper, manganese, zinc, molybdenum, chlorine, cobalt, or nickel whether synthetic or organic. Suitable fertilizers may be commercially sourced, such as Miracle-Gro water soluble plant food vegetable and herbs, Clonex, Dyna-Gro, M&S (Murashige and Skoog) or FloraMicro. As used herein “fertilizer”, which generally are classified according to their NPK content. NPK is common terminology used in the fertilizer industry and stands for: (1)N—the amount of nitrogen in the formulation as N; (2) P—the amount of phosphorus in the formulation as P2O5; and (3) K—the amount of potassium in the formulation as K2O In other words, the N refers to nitrogen-containing compounds that are added to the soil and are utilized by the particular plant to satisfy its nitrogen requirement. The P refers to phosphorus-containing compounds that are added to the soil and are utilized by the particular plant to satisfy its phosphorus requirement (a nutrient required for plant growth). K refers to potassium-containing compounds that are added to the soil and are utilized by the particular plant to satisfy its potassium requirement (another nutrient essential for plant growth). Besides these nutrients, namely nitrogen, phosphorus and potassium, which are normally provided by the addition of fertilizers that typically are known as NPK fertilizers, other nutrients can also be provided by the addition of fertilizers to the soil Typical nutrients are calcium, magnesium, sulfur, iron, zinc, manganese, copper, boron, and molybdenum. The term “fertilizer” as used herein, unless expressly indicated otherwise, refers to NPK fertilizers, that is, fertilizers that include one or more of the nutrients (nitrogen, phosphorus and potassium).

“Cohesiveness” defines the cohesive properties of a polymer find direct expression in its solubility in organic liquids. The cohesive properties of a substance are expressed quantitatively in the cohesive energy. This quantity is closely related to the internal pressure, a parameter appearing in the equation of state of the substance.

“Dissolvable bag” as referred to in the present invention means a solid container that will convert into a suspension, colloid, or solution in the presence of a liquid.

“Hardness” is the resistance of a material to permanent indentation or maximum force of the gel Hardness can be measured in g/cm2.

A “hydrogel” is a crosslinked hydrophilic polymer that does not dissolve in water. They are highly absorbent yet maintain well defined structures.

“Plant” or “plant part” includes all parts of the plant, including: root, stem, meristem, seed, leaf, cotyledons, and the like.

“Plant plugs” (commonly referred to as in vitro plugs) as used herein are generally relatively small shaped bodies composed of a growth medium that serve for the cultivation and propagation of plants in a very early developmental stage. Plant plugs generally have a consistency which allows a manual or machine transfer of the plugs into other cultivation vessels or transport or processing units. Owing to their small size and transferability, plant plugs can be suitable for medium- and high-throughput methods in plant cultivation and can also be used for the space-saving transport of plants in an early developmental stage.

“Polysaccharide” as used herein, means a carbohydrate (e.g. starch, cellulose, or glycogen) whose molecules consist of a number of sugar molecules bonded together. Polysaccharides include gellan.

As used herein “soil” means either man-made or naturally occurring unconsolidated mineral or organic material on the immediate surface of the Earth that serves as a natural medium for the growth of land plants. Soil used for indoor growing is generally sterilized and devoid of added living biologic material.

“Springiness” is s the rate at which a deformed material goes back to its undeformed condition after deforming force is removed. It is a measurement of elastic recovery and has a unit of percent (%).

“Water” includes purified, distilled and reverse osmosis (RO) water, which may be charged as in some preferred embodiments of the present invention.

All publications and patent applications mentioned in this specification are herein incorporated by reference to the same extent as if each individual publication or patent application was specifically and individually indicated to be incorporated by reference.

No admission is made that any reference constitutes prior art. The discussion of the references states what their authors assert, and the applicants reserve the right to challenge the accuracy and pertinence of the cited documents. It will be clearly understood that, although a number of prior art publications are referred to herein, this reference does not constitute an admission that any of these documents forms part of the common general knowledge in the art.

The discussion of the general methods given herein is intended for illustrative purposes only Other alternative methods and embodiments will be apparent to those of skill in the an upon review of this disclosure.

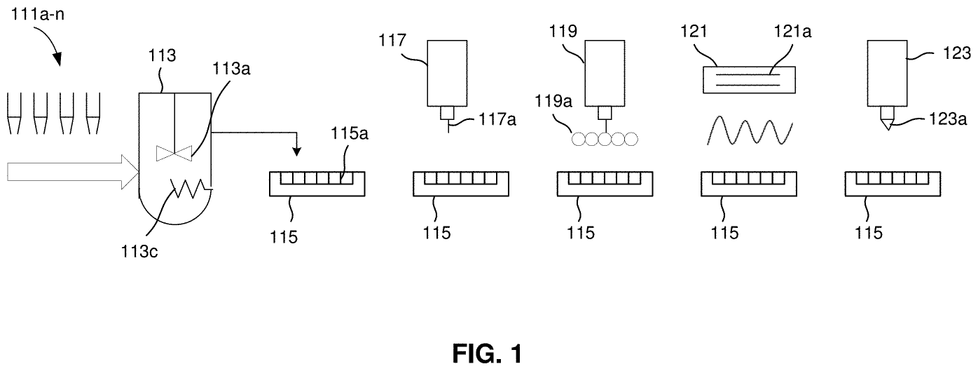

FIG. 1 is a process diagram for providing a gel-based seeded substrate or plug, generally ready for germination. A gelling formulation is provided to one or more reactors 113. The reactors may include a stirring element 113a for mixing components of the gelling formulation, and a heating element 113c for bringing the components to a desired temperature. In some embodiments a single reactor is used, in some embodiments multiple reactors are used, with various of the components of the gelling formulation provided to various of the reactors, with solutions in those reactors then provided to an ultimate reactor.

The gelling formulation includes a plurality of components, which may be provided by valved nozzles or hoppers 111a-n. In some embodiments the gelling formulation includes one or more polysaccharides as gelling agents, and a liquid or liquid solution.

The one or more polysaccharides may comprise, for example, an exopolysaccharide, carrageenan, a gellan gum, Gelrite (available from RPI Research Products International, IL), and/or chitosan. In some embodiments of the invention a hydrogel comprising water, carrageenan, carbon, and an acid to adjust pH has a hardness of between 100-1000 g/cm2, a cohesiveness of between 55-90%, and a springiness of 100%. More preferably, the hydrogels have a hardness of between 350-800 g/cm, a cohesiveness of 65-80%, and a springiness of 100%. In some embodiments the hydrogels have an electroconductivity measurement of between 3.0-5.0 mS/cm. In other preferred embodiments of the present invention the horticultural hydrogels have an electroconductivity measurement of between 3.5-4.9 mS/cm.

In some embodiments the fertigation solution is slightly acidic, and/or includes trace amounts of one, some, or all of Sodium Nitrate or other nitrogen source, potassium, copper, zinc, manganese, iron, boron, calcium, and/or magnesium. In some embodiments the solution has a conductivity between 1.0 and 1.4, inclusive, milliSiemens per centimeter. In some embodiments the solution includes added calcium and/or magnesium cations so as to have seed conductivity. In some embodiments the solution includes calcium and/or magnesium cations to provide divalent ions to bind to carboxylic acids of the Gelrite. In some embodiments the solution includes activated charcoal. In some embodiments fertigation solution is formed through the addition of various elements or ingredients of the fertigation solution to water, with the various elements or ingredients (and water) provided by way of the valved nozzles and/or hoppers. In some embodiments composition of the gel components and fertigation solution are determined by one or more processors. In some embodiments particular plants are associated with particular compositions of the gel components and fertigation solution, and the one or more processors may control operations of the valved nozzles and/or hoppers based on an identification of a plant received by the one or more processors.

In some embodiments a first solution is formed by dissolving 40-g of Gelrite (RPI Research Products International, IL) in 4-L of cold fertigation water. In some embodiments the fertigation water contains 850 ppm nitrate, 148 ppm calcium 259 ppm potassium, 39 ppm magnesium, 224 ppm sulfate, 0.11 ppm copper, 2.12 ppm zinc, 0.4 ppm manganese, 3.33 ppm iron, 0.31 ppm boron, and 0.05 ppm molybdenum.) The solution is stirred (for example at 400-500 rpm) until the Gelrite is completely dissolved/hydrated in the solution (<30-min). Preferably the pH is 5.6 and the EC is 1.4 milliSiemens per centimeter. A second solution may be formed by adding 35-mg of Chitosan (300-mg of Chitosan in some embodiments) to 200-mL of fertigation solution with stirring, and then adding 50-mL of Ethanol to the solution, adding 0.05-mL of HNO3, and heating the second solution to 90° C. Preferably the chitosan polymer has completely dissolved into the second solution. The second solution may be added to the first solution, and stirred for 30 or more minutes. In some embodiments small 200-mg aliquots of Ca(OH)2 may be added into the resulting solution until a pH of 6-7 is achieved. In some embodiments 5.6 g of Calcium Chloride, or, preferably, 7-g of Tetra Cor-Clear (available from Tetra Chemicals, TX) may also be added, with the solution mixed, for example for 15 minutes. In some embodiments 50-g of fine activated charcoal may also be added to the solution, and in some embodiments phytohormones may also be added.

The gelling solution, formed in the reactor(s), is poured into a tray 115. The tray may allow the gelling solution, once cooled, to form a growing substrate. Alternatively, the tray may have a plurality of cavities, for example formed by interior walls 115a of the tray, to allow the gelling solution, once cooled, to form gel plugs.

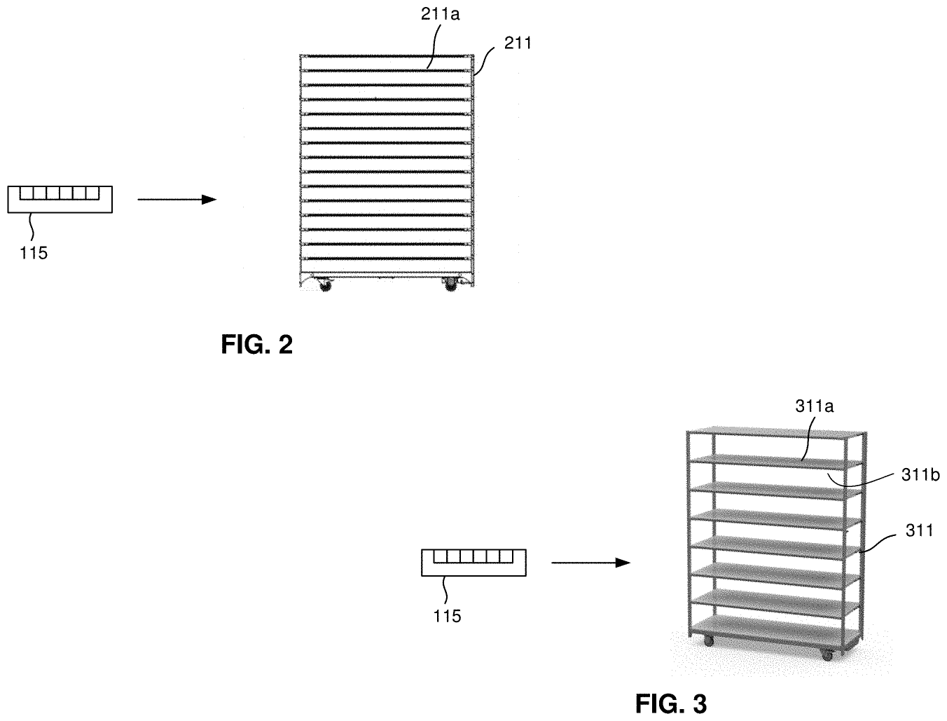

A conveyor (not shown in FIG. 2) transports the tray, once the gelling solution has cooled and thereby gelled, to a dibbler machine 117, which includes a dibbler tool 117a. The conveyor may be in the form of a conveyor belt, an automated cart, or other conveyance device. The dibbler dibbles an uppermost surface of the substrate or plugs, to allow for emplacement of seeds in the substrate or plugs. The conveyor and the dibbler machine may both be under the control of the one or more processors, which may for example control positioning and depth of operation of the dibbler tool.

The conveyor, or a further conveyor, may transport the dibbled substrate or plugs, still in the tray in some embodiments, to an optional roughener device 119. The roughener device includes a roughening, scratching, or abraiding tool 119a for roughening, scratching, or abraiding the upper surface of the substrate or plugs. The tool 119a may, for example, be in the form of wires or a wire mesh, which may be rotated either in the horizontal or vertical plane. The further conveyor and the roughener, like the other items of FIG. 1, may be under the control of the one or more processors, which may for example control horizontal and vertical position and rate of rotation of the tool 119a.

The conveyor, or a further conveyor, may also transport the dibbled substrate or plugs to an optional sanitizer device 121. The sanitizer device may be in the form of an ultraviolet (UV) lamp 121a, for example. In various embodiments the sanitizer device may be in the form of a sanitization spray device or sanitization submersion device. The sanitizer device may also be under control of the one or more processors, which for example may turn on the UV lamp for predetermined periods when the processor is informed of presence of the substrate or plugs under the UV lamp.

The conveyor, or a further conveyor, also transports the substrate or plugs to a seeding machine 123. The seeding machine emplaces seeds in the substrate or plugs, using a seeding tool 123a. The seeding machine generally emplaces the seeds in the dibbles in the upper surface of the substrate or plugs. The seeding machine may be under the control of the one or more processors, which for example may control positioning of the seeding tool based on information of relative locations of dibble locations, provided either both to the dibbler machine and the seeding machine or from the dibbler machine to the seeding machine.

FIG. 2 is a process diagram for transfer of gel-based substrates or plugs to a leaf carrier for germination. In FIG. 2, a conveyor (not shown in FIG. 2) transports a tray with seeded plugs (or just seeded plugs, in some embodiments, or a seeded substrate, to a shelf 211a in a leaf rack 211. The leaf rack may be located in a nursery, for example a climate controlled room, or the leaf rack may be subsequently moved to the nursery. The tray with seeded plugs (or just seeded plugs) or seeded substrate may be as discussed with respect to FIG. 1, and the operation represented by FIG. 2 may follow in response to the seeding of the plugs or substrate discussed with respect to FIG. 1.

FIG. 3 is a process diagram for transfer of gel-based substrates or plugs to an LED grow trolley for germination. A conveyor (not shown in FIG. 3) transports a tray with seeded plugs (or just seeded plugs, in some embodiments, or a seeded substrate, to a shelf 311a in the LED grow trolley 311. An underside of the shelf may include LED lights 311b. The LED grow trolley may be located in a nursery, for example a climate controlled room, or the leaf rack may be subsequently moved to the nursery. The tray with seeded plugs (or just seeded plugs) or seeded substrate may be as discussed with respect to FIG. 1, and the operation represented by FIG. 3 may follow in response to the seeding of the plugs or substrate discussed with respect to FIG. 1.

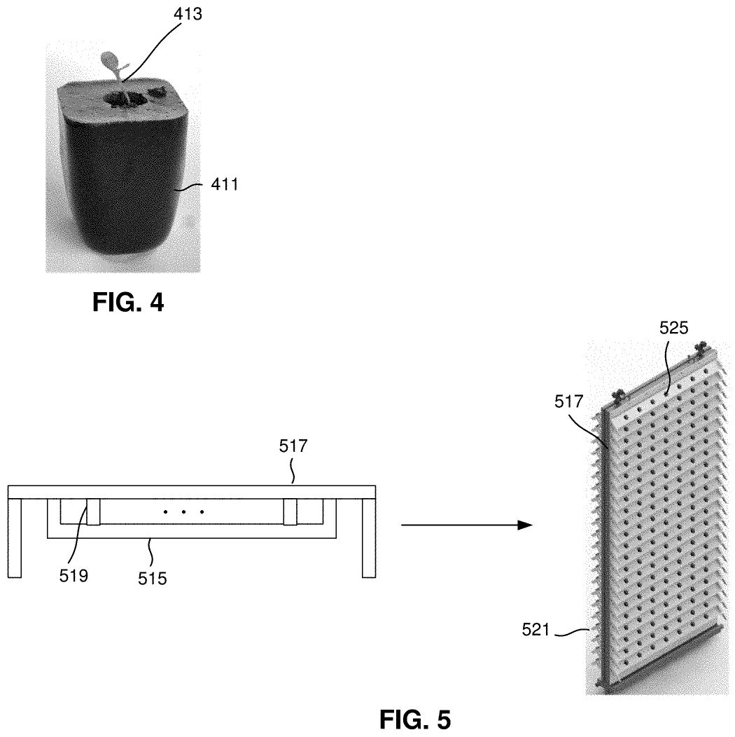

FIG. 4 shows a seedling 413 growing in an example of a gel plug 411. The seedling is growing out of a dibble formed in a top surface of the gel plug. The gel plug of FIG. 4 may be formed, for example, as discussed with respect to FIG. 1. The gel plug has a same shape as that of a volume of the cavity of the plant tray. In FIG. 4, the shape of the plug includes sidewalls defining a substantially square cross-section with rounded corners, tapered slightly towards a bottom of the plug.

FIG. 5 is a process diagram for transfer of gel plugs 519 in a bracket 517 to a grow wall 521. The bracket, for example, may include a lengthwise beam that spans a top of a tray 515, such as the tray of FIG. 1 or a similar tray, with the beam including apertures 525 for holding seeded gel plugs. A robotic arm may transport the bracket, for example by grasping an arm extending at an end of the bracket, to a grow wall. The grow wall, in some embodiments, may be an aeroponics grow wall. The aeroponics grow wall may include a frame and walls forming a housing enclosing a volume in which mist or fog may be provided. The wall may include apertures to receive the seeded gel plugs (with the dibbles exterior to the volume of the grow wall).

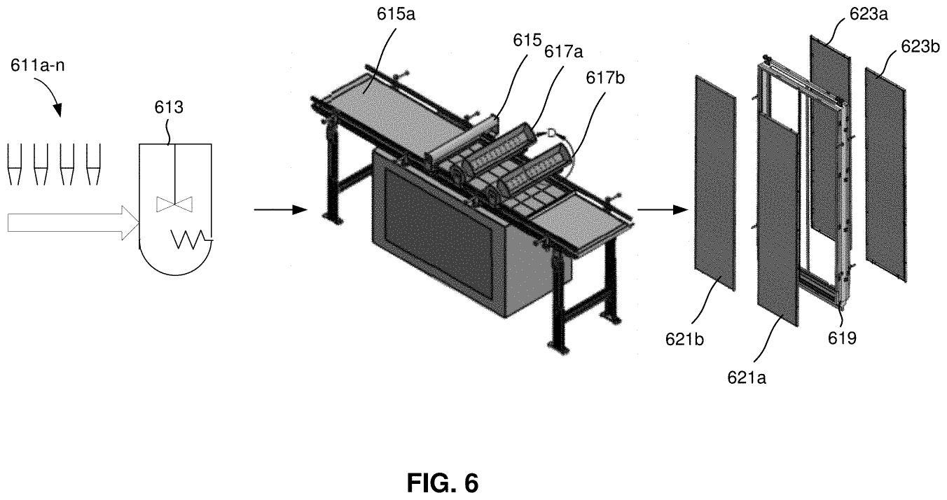

FIG. 6 shows a process flow diagram for automated preparation of a mesh or mat grow wall. As discussed with respect to FIG. 1, valved nozzles and/or hoppers 611a-n under the control of one or more processors provides gelling formulation to one or more reactors 113. The reactors may include a stirring element for mixing components of the gelling formulation, and a heating element for bringing the components to a desired temperature, all for forming a gelling solution. The gelling solution may be as discussed with respect to FIG. 1.

The gelling solution is provided to a gelling solution applicator 615. The gelling solution applicator 615 is arranged over a conveyor belt, which carries a substrate 615a such as a screen mesh or a mat. In some embodiments the substrate is first passed under seeding machines(s) 617a,b, and then passed under the gelling solution applicator. The gelling solution applicator may have nozzles or sprayer heads for spraying gelling material, in solution, onto the substrate carried by the conveyor belt. The gelling material applicator may be configured to spray a predetermined quantity of solution over a predetermined quantity of time. This, along with speed of the conveyor belt, also allows for application of a generally predetermined thickness of gel over the substrate. In some embodiments, in addition, heating elements may be provided right before or with nozzles of the gelling material applicator, to assist in ensuring that the gelling material does not gel prior to application to the substrate.

The seeded substrate may be conveyed, for example by a robotic arm under control of the one or more processors, to a frame 619 for a grow wall. In some embodiments the grow wall may allow for emplacement of multiple seeded substrates, for example substrates 621a,b and 623a,b, which may form opposing walls of an aeroponics grow chamber.

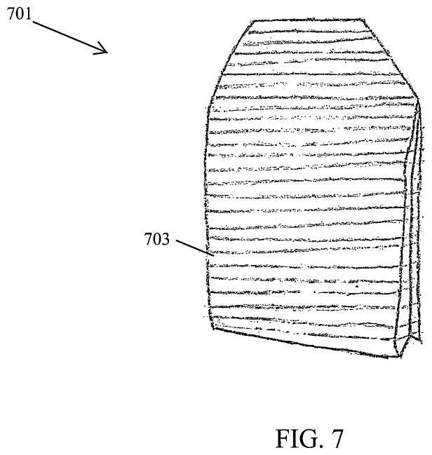

FIG. 7 is an illustration of a dissolvable bag containing wet and dry ingredients of the horticultural hydrogel. The dissolvable bag 701 may be placed in a reactor and water may be added to make the horticultural hydrogels, after which are formed into plugs, sheets, or other shapes for plant germination and growth. In some embodiments the dissolvable bag has dissolvable walls 703 that may be dissolved with contact with water, specifically charged water.

In preferred embodiments, a dissolvable bag having wet and dry ingredients for a preferred horticultural hydrogel formulation is received by a user. The user places the dissolvable bag in a reactor that receives charged water. The mixture of the dissolvable bag, having the ingredients of horticultural hydrogel inside, and water is stirred and heated in the reactor and the resultant liquid hydrogel is poured into a preferred receptacle (e.g., plug, sheet, container), and cooled. The cooled horticultural hydrogel is indented with a dibbler to receive a seed and placed in a first growth position. The seeds placed within the indent germinate and grow to an early growth stage. At the early growth stage, the plants within the receptacle are moved to a second growth position. There the plants grow until harvest.

Although the invention has been discussed with respect to various embodiments, it should be recognized that the invention comprises the novel and non-obvious claims supported by this disclosure.

1. An automated system for plant growth comprising:
a reactor, the reactor having a mixing element and a heating element, the reactor receiving a plurality of components to make a hydrogel solution;
a processor, wherein the processor controls at least one hopper and at least one valve to deliver the plurality of components to make the hydrogel solution in the reactor, and wherein the hydrogel solution is poured into a tray to create a hydrogel mat or a hydrogel plug;
at least one conveyor to move the hydrogel mat or the hydrogel plug to a nursery on a path, wherein on the path, the hydrogel mat or the hydrogel plug is seeded and is dibbled or scratched;
the nursery further comprising a first position for a seed to germinate in the hydrogel mat or the hydrogel plug, and a second position for a plant to grow to a harvest state in the hydrogel mat or the hydrogel plug, the nursery further comprising a plurality of LED lights suitable for germination and growth.

2. The automated system of claim 1, wherein the hydrogel mat is in a vertical position during germination and in a horizontal orientation for growth of the plant.

3. The automated system of claim 1, wherein the tray has an expanding mechanism to accommodate the plant's growth.

4. The automated system of claim 1, wherein the plurality of components to make the hydrogel solution are in a dissolvable bag, the dissolvable bag placed in the reactor with water to make the hydrogel mat or the hydrogel plug.

5. The automated system of claim 1, wherein the hydrogel plug is dibbled before a seed is placed in the indention therein.

6. The automated system of claim 1, wherein movement from the first position to the second position is automated.

7. An automated process for plant germination and growth comprising:
making a horticultural hydrogel in a reactor, the horticultural hydrogel further comprising: charged water, carrageenan, carbon, fertilizer and a pH balancing element, wherein the horticultural hydrogel is stirred and heated to 85° C.;
pouring the horticultural hydrogel into a receptacle and cooling the horticultural hydrogel to below 70° C.,
placing an indention in the horticultural hydrogel with a dibbler;
placing a seed in the indention making a seeded horticultural hydrogel;
placing the seeded horticultural hydrogel under conditions for germination in a first grow station;
the seed growing to an early growth stage plant, and moving the seeded horticultural hydrogel to a second grow station; and
the early growth stage plant growing to a harvest stage in said second grow station.

8. The automated process of claim 7, wherein movement from the first grow station to the second grow station is automatic.

9. The automated process of claim 7, wherein at least one processor is used to dispense the charged water, carrageenan, carbon, fertilizer and a pH balancing element to make the horticultural hydrogel.

10. The automated process of claim 7, wherein at least one conveyer is used to transport the seeded horticultural hydrogel from the first grow station to the second grow station.
